(19) United States
(12) Patent Application Publication
(10) Pub. No.: US 2026/0184366 A1
(43) Pub. Date: Jul. 2, 2026

(54) ELECTRIC STEERING SYSTEM AND VEHICLE COMPRISING THE STEERING SYSTEM

(71) Applicant: ZF FRIEDRICHSHAFEN AG, Friedrichshafen (DE)

(72) Inventors: INGO BECKER, LINNICH (DE); JOCHEN SCHERBART, Cologne (DE)

(21) Appl. No.: 19/131,959

(22) PCT Filed: Dec. 7, 2023
(86) PCT No.: PCT/EP2023/084683

§ 371 Date: May 22, 2025

(30) Foreign Application Priority Data
Dec. 8, 2022 (DE) 10 2022 213 251.3

(51) Int. Cl. B62D 5/04

(52) U.S. Cl. CPC B62D 5/0403; B62D 5/046

(57) ABSTRACT

An electric steering system includes a sensor that records steering information from a steering shaft, an electric drive unit, and a steering gear. The electric drive unit generates an auxiliary force and has a servomotor and a control apparatus that controls the servomotor based on the recorded steering information. The steering gear has a gear housing, which has a first gear input for connecting a drive shaft to the electric drive unit, a second gear input for connecting the steering shaft to the sensor and a gear output for connecting an output shaft to a steerable vehicle wheel. The electric drive unit is connected to the gear housing at the first gear input and the sensor is connected to the gear housing at the second gear input. The sensor and the electric drive unit are connected to one another, via a lead frame arranged in the gear housing.

### CROSS REFERENCE TO RELATED APPLICATIONS

This application is a U.S. National Phase application under 35 U.S.C. § 371 of International Application No. PCT/EP2023/084683, filed on Dec. 7, 2023, and claims benefit to German Patent Application No. DE 10 2022 213 251.3, filed on Dec. 8, 2022. The International Application was published in German on Jun. 13, 2024 as WO 2024/121294 A1 under PCT Article 21(2).

### FIELD

The disclosure relates to an electric steering system. The disclosure also relates to a vehicle comprising the steering system.

### BACKGROUND

Electric power-assisted steering (EPS) systems today combine a plurality of electrical components, such as torque and angle sensors, electric servomotor, control device, etc., for exchanging data and supplying energy. These components are usually connected to one another via externally laid wire harnesses, which must meet high demands in terms of robustness.

Document DE 10 2004 006 835 A1 discloses a steering system for a vehicle, in particular an electrically assisted power steering system for a motor vehicle, comprising a steering spindle that connects a steering handle at one end to a rotary slide or rotary piston of a steering valve via a first torsion element. The steering system has a hydraulic servomotor for actuating an output member of a steering gear, wherein a pressure medium flow into working spaces of the hydraulic servomotor is controlled by the steering valve. Furthermore, the steering system has an electric servomotor for actuating the output member, wherein the electric servomotor and the steering spindle act on a common rotary member between the first torsion element and the rotary slide or rotary piston. The electric servomotor is controlled by way of an open-loop control and/or closed-loop control apparatus of the steering system or of the vehicle on the basis of signals from a rotational angle sensor, which records a rotational angle and/or an actuation torque on the steering handle.

### SUMMARY

In an embodiment, the present disclosure provides an electric steering system, including: a sensor unit, wherein the sensor unit has at least one sensor for recording steering information from a steering shaft; an electric drive unit for generating an electrical auxiliary force, wherein the electric drive unit has an electric servomotor and a control apparatus, wherein the control apparatus is designed to control the electric servomotor based on the recorded steering information; and a steering gear, wherein the steering gear has a gear housing, which has a first gear input for connecting a drive shaft to the electric drive unit, a second gear input for connecting the steering shaft to the sensor unit and a gear output for connecting an output shaft to at least one steerable vehicle wheel, wherein the electric drive unit is connected to the gear housing at the first gear input and the sensor unit is connected to the gear housing at the second gear input, wherein the sensor unit and the electric drive unit are connected to one another, electrically and/or in terms of signaling, via a lead frame arranged in the gear housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a steering system for a vehicle;

FIG. 2 shows a schematic illustration of a lead frame for the steering system from FIG. 1;

FIG. 3 shows a schematic illustration of a drive unit for the steering system from FIG. 1;

FIG. 4 shows an alternative embodiment of the drive unit in the same illustration as FIG. 3; and

FIG. 5 shows a schematic illustration of a steering gear for the steering system from FIG. 1.

### DETAILED DESCRIPTION

In accordance with an embodiment, the present disclosure provides a steering gear of the type mentioned at the outset, which is characterized by a robust configuration and a simple electrical connection of the electrical components.

In accordance with another embodiment, the present disclosure provides is an electric steering system that is in particular designed and/or suitable for a vehicle. The electric steering system is preferably used to implement a steering command, which is generated by a steering handle, mechanically and/or electrically, in particular electromechanically, on at least one steerable vehicle wheel.

The steering system has a sensor unit that has one or more sensors, which is/are designed and/or suitable for recording steering information on a steering shaft. In particular, the steering information comprises a steering angle and/or a steering torque and/or a steering speed and/or a steering acceleration. The sensor may be, for example, in the form of a position sensor, in particular a rotary encoder, and/or a torque sensor.

The steering system has an electric drive unit, which has an electric servomotor for generating an electrical auxiliary force and a control apparatus for controlling the servomotor on the basis of the recorded steering information. In particular, the sensor unit is designed to transmit the recorded steering information to the control apparatus, wherein the control apparatus is designed to subject the position information to data processing and/or to forward it to a superordinate control device. The control apparatus or, if applicable, the control device may have an evaluation module, e.g. a microprocessor, which is designed to evaluate the steering information and/or to take it into account when determining a wheel steering angle to be set on the vehicle wheels. In particular, the evaluation module is designed to ascertain an actual wheel steering angle of the vehicle wheels on the basis of the steering information and/or to take the steering information into account when determining a target wheel steering angle.

The steering system additionally has a steering gear, which is in particular designed and/or suitable for transmitting a steering movement to one or more vehicle wheels of the vehicle. The steering gear has a gear housing, which has a first gear input for connecting a drive shaft to the drive unit, a second gear input for connecting the steering shaft to the sensor unit and a gear output for connecting an output shaft to at least one, or precisely one, steerable vehicle wheel. In this case, the drive unit is connected to the gear housing at the first gear input and the sensor unit is connected to the gear housing at the second gear input. The drive shaft, the steering shaft and the output shaft are able to be connected to one another in terms of gear technology, preferably via a superposition gear. The drive shaft and the steering shaft are preferably connected to one another in terms of gear technology via a transmission gear and the steering shaft and the output shaft via a worm gear. In principle, the steering movement is able to be implemented exclusively by the electric servomotor (steer-by-wire) or transmitted to the steering shaft. Optionally, the steering shaft may be connected to a steering spindle or steering column in order to transmit an actuating torque applied by the steering handle, in particular a steering wheel, to the steering shaft. The electric servomotor is therefore used for steering assistance.

The drive shaft may have a first input interface arranged on the first gear input, to which the servomotor is connected and/or is able to be connected in terms of drive for transmitting a torque or rotational movement generated by the electric servomotor. The steering shaft may have a second input interface arranged on the second gear input, on which the sensor unit is arranged and/or is able to be arranged for recording the steering information. Optionally, the steering handle is connected and/or is able to be connected in terms of drive to the second input interface, preferably for transmitting a manual torque. The output shaft may have an output interface that is arranged on the gear output and is connected to the at least one vehicle wheel via known kinematic connections in order to change a wheel steering angle on the vehicle wheel when the output shaft is rotated. Preferably, the first and/or the second input interface and/or the output interface are/is formed as a shaft journal, the end of which protrudes from the gear housing.

Within the context of the disclosure, it is proposed that the sensor unit and the drive unit are connected to one another, electrically and/or in terms of signaling, via a lead frame arranged in the gear housing. In particular, the lead frame extends between the first and the second gear input inside the gear housing, with the result that the lead frame is protected or shielded from the environment by the gear housing. The lead frame is preferably mounted at a fixed location in the gear housing and/or integrated into the gear housing.

The disclosure is based on the finding that the use of electrical cable bundles that are laid externally to, i.e. outside of, the gear housing, provides only weak protection against mechanical and electrical influences. In addition, there are other disadvantages, such as a lack of protection against incorrect operation, packaging restrictions, a high number of external plug-in connectors, a high level of outlay for sealing methods and relatively high installation costs during production. The lead frame installed in the gear housing makes it possible to eliminate or reduce the disadvantages mentioned above. A steering system that is characterized by a robust configuration and a simple electrical connection of the electrical components is therefore proposed.

In one specific configuration, provision is made for the lead frame to be designed to be rigid or substantially rigid. The term “substantially rigid” should be understood to mean that the lead frame does not comprise a flexible material or has an increased stiffness compared to cables that are usually used. In particular, the lead frame is formable or plastically deformable in order to shape the lead frame to a corresponding geometry of the surroundings. A lead frame that is characterized by a robust design and simple installation in the gear housing is therefore proposed.

In a further specific embodiment, provision is made for the lead frame to have a plurality of individual conductors that are electrically insulated from one another and, at their free ends, each form an electrical contact for at least indirectly connecting the drive unit and/or the sensor unit. In particular, the individual conductors are in the form of rigid, preferably metallic conductors, such as wires or strips, for example. The individual conductors are preferably arranged so as to be flat and adjacent to one another and/or evenly spaced apart from one another. Particularly preferably, at least some of the individual conductors are designed and/or suitable for transmitting electrical energy and/or at least some of the individual conductors are designed and/or suitable for transmitting signals. A lead frame that is characterized by a simple and cost-effective design is therefore proposed.

The lead frame has an electrically insulating potting body. In particular, the individual conductors, apart from the free ends, are completely embedded in the potting body. The individual conductors are preferably mechanically connected to one another by way of the potting body. The potting body may be formed by a rigid or a flexible potting compound, for example a plastic compound or a resin compound. The individual conductors are particularly preferably embedded in the potting compound by means of an injection molding method, in particular by means of overmolding, to produce the potting body. A lead frame that is characterized by simple manufacture and high mechanical protection of the individual conductors is therefore proposed.

In a further specification, provision is made for the lead frame to form, or to contribute to forming, on the side of the first gear input, a first connection interface for electrically connecting the drive unit and, on the side of the second gear input, a second connection interface for electrically connecting the sensor unit. In particular, the electrical contacts are able to be electrically contact-connected via the first or the second connection interface. In principle, the electrical contacts at the first and/or the second connection interface may be electrically connected to the drive unit or the sensor unit by means of a mechanical and/or material-bonding connection method. Preferably, however, the first and/or the second connection interface are/is designed and/or suitable for forming an electrical plug-in connection. The drive unit and the sensor unit are particularly preferably able to be connected to the lead frame automatically when mounted on the gear housing via the respective connection interface, preferably the electrical plug-in connection. The drive unit and/or the sensor unit are preferably able to be mounted in precisely one orientation on the gear housing, in which the plug-in connection is likewise manufactured and/or able to be manufactured. An electrical connection of the drive unit and the sensor unit that is characterized by particularly simple and installation-friendly handling is therefore proposed.

In one development, provision is made for the first and/or the second connection interface for forming the electrical plug-in connection to be in the form of a socket integrated into the gear housing or a plug integrated into the gear housing. The electrical contacts are preferably in electrical contact with the connections of the plug or the socket. The drive unit and/or the sensor unit may particularly preferably be in the form of modules, wherein the respectively associated connection interface forms a modular connection or a standard interface for various embodiment variants of the drive unit or the sensor unit. In particular, the different drive units and/or sensor units each have a counterpart interface complementary to the first or the second connection interface. A steering system that is characterized by a small number of plug-in connections and at the same time allows a modular design is therefore proposed.

In a further configuration, provision is made for the control apparatus to have a printed circuit board, wherein the printed circuit board is connected to the first connection interface directly via a printed circuit board connection or via at least one, or precisely one, electrical intermediate component. By way of example, the printed circuit board may be arranged or oriented in the drive unit in such a way that it is able to be connected and/or is connected to the first connection interface directly via the printed circuit board connection. Alternatively, the printed circuit board connection of the printed circuit board is electrically connected to the first connection interface via the electrical intermediate component. The first connection interface particularly preferably forms a transfer point between the lead frame and the intermediate component. For this purpose, the electrical intermediate component has a counterpart interface complementary to the first connection interface. In addition, the intermediate component has a further counterpart interface, which is designed to be complementary to a printed circuit board connection of the printed circuit board. The electrical intermediate component may optionally be completely installed, or at least sections of it may be installed, inside the connection unit. A drive unit that is characterized by a simple and flexible connection to the steering gear is therefore proposed.

In a further possible configuration, provision is made for the electrical intermediate component to be in the form of a further lead frame that connects the printed circuit board to the first connection interface. In particular, the drive unit has a drive housing, wherein the electric servomotor and the control apparatus are received inside the drive housing. The further lead frame may be integrated into the drive housing and/or at least sections thereof may be mounted inside the drive housing. The further lead frame preferably has the same design as the lead frame. This means that the further lead frame has a plurality of individual conductors, which are preferably embedded in a further potting body. A drive unit that is characterized by a robust electrical connection of the control apparatus is therefore proposed.

In one alternative implementation, provision is made for the electrical intermediate component to be in the form of a connection cable that is guided in a protected manner inside the drive housing or in a separate protective tube inside or outside of the drive housing and that connects the printed circuit board to the first connection interface. By way of example, the connection cable is in the form of an adapter cable, which is designed and or suitable for forming the plug-in connection to the first connection interface and/or for forming a further plug-in connection to the printed circuit board connection. A steering system that is characterized by a simple and flexible electrical connection of the drive unit is therefore proposed.

In a further specification, provision is made for the at least one sensor to be connected to the second connection interface via a connecting cable that is guided in a protected manner. The sensor unit preferably has a sensor housing, wherein the connecting cable is guided inside the sensor housing in a protected manner to the at least one sensor. The connecting cable is preferably laid freely or inside a further protective tube inside the sensor housing. In principle, the connecting cable may be in the form of a sensor cable that is already integrated into the sensor and is connected and/or is able to be connected to the second connection interface via a plug-in connection. Alternatively, the sensor cable is connected and/or is able to be connected to the sensor via an additional plug-in connection. A steering system that is characterized by a simple and cost-effective connection of the sensor unit to the gear housing or the lead frame is therefore proposed.

In a further development, provision is made for the gear housing to have a guide contour complementary to the lead frame, wherein the lead frame interacts with the guide contour with a form-fit and/or with a force-fit. In particular, the guide contour is used to keep the lead frame in the housing at a fixed location and/or in a captive manner. At least sections of the lead frame are particularly preferably inserted inside the guide contour so that the lead frame is fixed to the gear housing. By way of example, the guide contour may be formed by one or more elevations or depressions that are formed directly on the gear housing and form at least one partially negative contour of the lead frame. The lead frame is particularly preferably able to be connected to the guide contour in just one single orientation, with the result that a particularly high level of mounting reliability is ensured. In particular, the gear housing may be in the form of a cast housing, wherein the guide contour is manufactured by a forming technique, preferably in a casting method. A steering gear that is characterized by a particularly cost-effective design, wherein the lead frame is simultaneously mounted inside the gear housing in a simple manner, is therefore proposed.

In a further specification, provision is made for the guide contour to be formed by at least one, or precisely one, guide groove into which at least sections of the lead frame are inserted. In particular, the lead frame is held inside the guide groove with a force-fit, e.g. by way of a press fit. Sections of the lead frame particularly preferably extend inside the gear housing so as to be parallel to and/or aligned with an axis of rotation of the steering shaft and/or the drive shaft, wherein the gear housing has at least one guide groove running in the axial direction with respect to the axis of rotation and/or at least one, or precisely one, guide groove running in the radial direction with respect to the axis of rotation in order to receive the lead frame. Particularly simple and cost-effective mounting of the lead frame inside the gear housing is therefore proposed.

In an alternative or optionally additional development, provision is made for the gear housing to have at least one, or precisely one, fastening receptacle and the lead frame to have at least one, or precisely one, fastening section, wherein the fastening section is received in the fastening receptacle with a form-fit and/or with a force-fit. In a mounting state, the fastening section engages into the fastening receptacle in such a way that the lead frame is fixed and/or captively retained inside the gear housing. The fastening receptacle may preferably be in the form of a depression, hole or recess made in the gear housing, into which the fastening section is inserted and/or is able to be inserted. By way of example, the at least one fastening section may be in the form of a stud, pin, latching lug or snap-action hook, which is able to be brought into engagement with the associated fastening receptacle with a form-fit and/or with a force-fit. The fastening section is particularly preferably integrally connected to the potting body, preferably from a common material section, or is formed on the potting body. The fastening sections of the lead frame are particularly preferably able to be inserted into the fastening receptacles by way of a plug-in movement. A lead frame that is characterized by simple mounting on the gear housing is therefore proposed. As a result of a combination of a guide contour and fastening sections, it is additionally possible to ensure particularly reliable mounting.

In a further configuration, provision is made for the lead frame to be shaped to the inner contour of the gear housing so that the lead frame is received in the gear housing without play and/or without a gap. In particular, the gear housing has a plurality of recesses and/or projections, wherein the lead frame is adapted to the inner contour of the gear housing by way of forming. In particular, the lead frame may lie largely or preferably completely flat against the gear housing between the connection interfaces. A steering gear that is characterized by a particularly space-saving arrangement of the lead frame inside the gear housing is therefore proposed.

In a further optional configuration, provision is made for the electric steering system to be in the form of an electric power-assisted steering (EPS) system. In a steering operation, a steering angle is specified by means of the steering handle as a measure for a desired wheel steering angle for the at least one steerable wheel, wherein the electric servomotor provides an additional torque for steering assistance. In particular, the electric servomotor is connected to the steering shaft in a torque-transmitting manner for this purpose.

A further subject of the disclosure relates to a vehicle comprising the electric steering system as already described above. The vehicle may be a passenger car, an agricultural or construction machine or a commercial vehicle.

Further features, advantages and effects of the disclosure emerge from the following description of preferred exemplary embodiments of the disclosure.

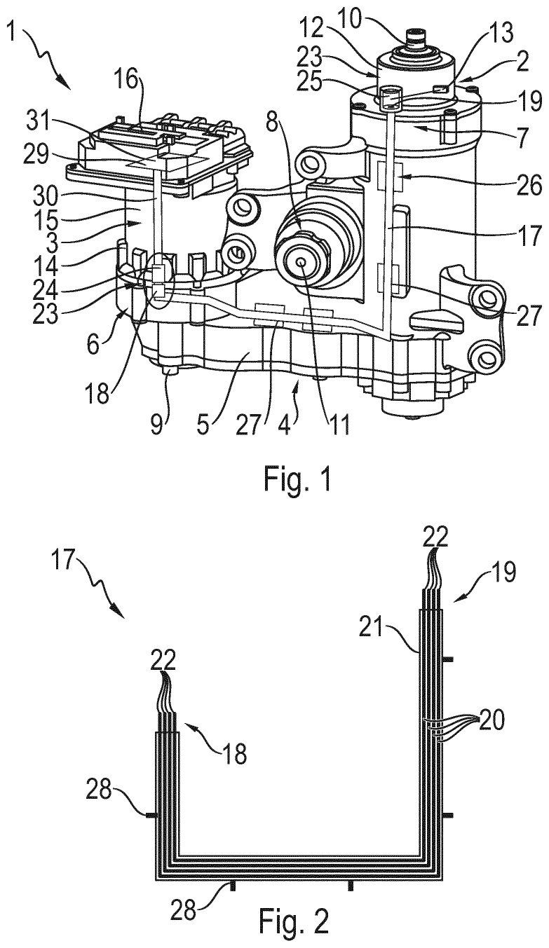

FIG. 1 shows a schematic illustration of an electric steering system 1 for a vehicle as an exemplary embodiment of the disclosure. The electric steering system 1 is in the form of an electric power-assisted steering (EPS) system.

The steering system 1 has a sensor unit 2, an electric drive unit 3 and a steering gear 4. The steering gear 4 has a gear housing 5, which has a first and a second gear input 6, 7 and a gear output 8. The electric drive unit 2 is arranged on the gear housing 5 at the first gear input 6 and the sensor unit 3 is arranged on the gear housing 5 at the second gear input 7.

The steering gear 4 has a drive shaft 9, a steering shaft 10 and an output shaft 11, which are connected to one another in terms of gear technology. The drive shaft 9 and the steering shaft 10 are oriented so as to be aligned with one another, and the output shaft 11 and the steering shaft 10 are oriented transversely to one another. In other words, the drive shaft 9 defines a first axis of rotation and the steering shaft 10 defines a second axis of rotation, wherein the first and the second axis of rotation extend axially parallel to one another. The output shaft 11 defines a third axis of rotation, wherein the first or the second axis of rotation and the third axis of rotation intersect one another, in particular at right angles, in a plan view. By way of example, the drive shaft 9 is connected to the steering shaft 10 in terms of gear technology via a single-stage or multi-stage transmission gear, e.g. a spur gear, and the output shaft 11 is connected to the steering shaft 10 in terms of gear technology via a worm gear.

The sensor unit 2 has a sensor housing 12 and at least one sensor 13 that is arranged inside the sensor housing 12 and is designed to record steering information, e.g. a steering torque and/or a steering angle, from the steering shaft 10. By way of example, the sensor 13 may be in the form of a combined steering torque and steering angle sensor (TAS). For this purpose, the steering shaft 10 is guided out of the gear housing 5 via the second gear input 7 and through the sensor housing 12. By way of example, the end of the steering shaft 10 on the side of the sensor unit 2 may be connected to a steering handle, which is not shown, via a steering column, wherein a steering movement is able to be applied to the steering shaft 10 via the steering handle.

The drive unit 3 has a drive housing 14 and an electric servomotor 15 arranged in the drive housing 14 and a control apparatus 16 arranged in the drive housing 14. The electric servomotor 15 is designed to apply an additional torque to the steering shaft 10 on the basis of the steering information. For this purpose, the control apparatus 16 is designed to subject the electric servomotor 15 to open-loop and/or closed-loop control on the basis of the steering information. The drive shaft 9 is guided out of the gear housing 5 via the first gear input 6 and connected to the electric servomotor 15 in terms of drive.

The steering gear 4 is used to adjust a wheel steering angle of the vehicle on the basis of a rotation of the steering shaft 10. For this purpose, the output shaft 11 of the steering gear 4 is connected to the steerable vehicle wheels in a known manner via a steering linkage, which is not shown, in order to convert a rotational movement of the output shaft 11 into a linear movement of a steering rod of the steering linkage and to adjust a corresponding wheel steering angle on the corresponding vehicle wheel.

Furthermore, the steering system 1 has a lead frame 17, via which the at least one sensor 13 and the control apparatus 16 are electrically conductively connected to one another in order to transmit electrical energy and/or signals. The lead frame 17 is designed to be substantially rigid and mounted at a fixed location inside the gear housing 5. The lead frame 17 is electrically connected to the control apparatus 16 at the first gear input 6 via a first connection interface 18 and to the sensor 2 at the second gear input 7 via a second connection interface 19. A steering system 1 that is configured to be free of externally laid cables or cable bundles, as indicated in FIG. 1, between the sensor unit 2 and the drive unit 3 is therefore proposed.

As shown in FIG. 2, the lead frame 17 has a plurality of electrically conductive individual conductors 20, which are embedded together in an electrically insulating potting body 21. By way of example, the individual conductors 20 are arranged so as to be flat and adjacent to one another and/or evenly spaced apart from one another. The potting body 21 may be produced by means of plastic injection molding, e.g. by means of overmolding.

In order to form the first and the second connection interface 18, 19, the ends of the individual conductors 20 are exposed, with the result that they each form an electrical contact 22. The steering system 1 is of modular construction, wherein the first and the second connection interface 18, 19 form a standardized transfer point for the sensor unit 2 and the drive unit 3, respectively, for reasons of modularity. To this end, the first and the second connection interface 18, 19 may be formed, for example, by a socket integrated into the gear housing 5, for example to form a plug-in connection 23, wherein the electrical contacts 22 each form connections of the socket. Accordingly, the drive unit 3 and the sensor unit 2 each have a first or a second counterpart interface 24, 25 that are complementary to the first or the second connection interface 18, 19 and are each in the form of a plug, for example, in order to form the plug-in connection 23.

As shown in FIG. 1, the gear housing 5 has a guide contour 26, via which the lead frame 17 is captively received inside the gear housing 5. The guide contour 26 is formed by a plurality of guide grooves 27 formed on the gear housing 5, into which sections of the lead frame 17 are inserted. By way of example, the lead frame 17 may be received or held in the guide grooves 27 with a force-fit and/or with a form-fit.

Furthermore, a plurality of fastening sections 28 may be arranged on the potting body 21, which engage with fastening receptacles, which are not shown, that are correspondingly arranged in the gear housing 5 in order to additionally secure the lead frame 17. By way of example, the fastening sections 28 are in the form of studs formed on the potting body 21 and the fastening receptacles are in the form of holes made in the gear housing 4 in which the studs are received or held with a form-fit and/or a force-fit.

The lead frame 17 is configured to be deformable, wherein the lead frame 17 is adapted or able to be adapted to an inner contour of the gear housing 5 by way of forming. The lead frame 17 may therefore be installed inside the gear housing 5 in a particularly space-saving manner and may be adapted to different housing designs in a simple manner.

As shown in FIG. 1, the control apparatus 16 has a printed circuit board 29 that is connected to the first connection interface 18 via an electrical intermediate component 30. For this purpose, the intermediate component 30 has the first counterpart interface 24, on the one hand, and is electrically connected to a printed circuit board connection 31 of the printed circuit board 29 via a further counterpart interface 32, on the other hand.

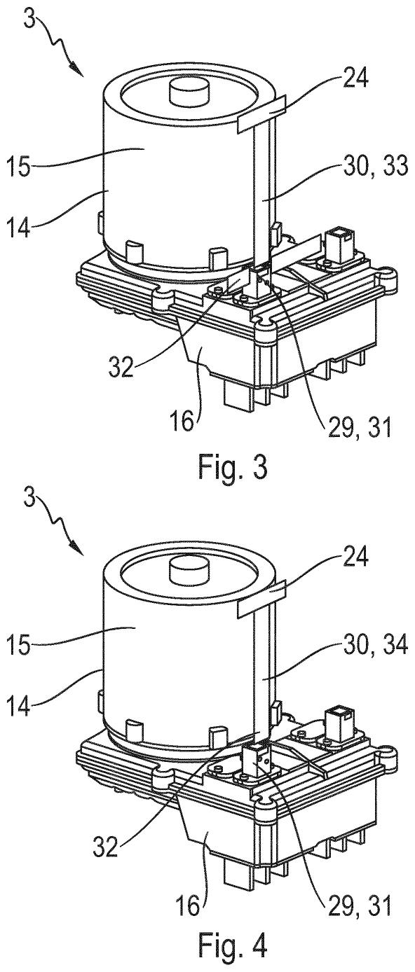

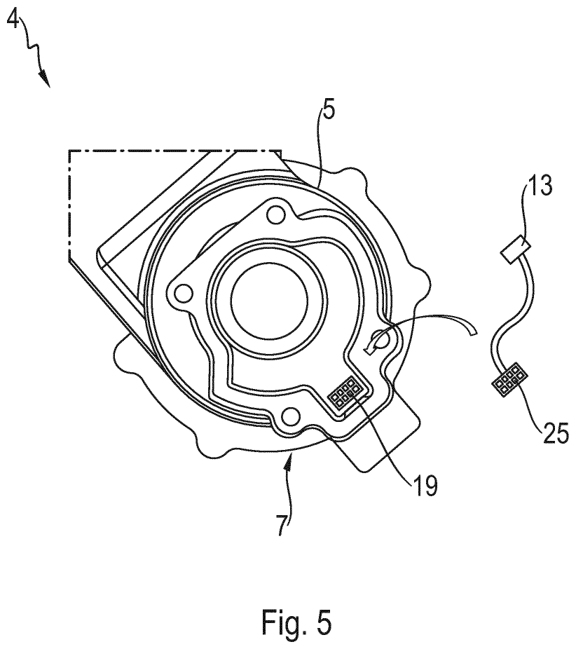

FIGS. 3 and 4 each show two different connection variants of the printed circuit board connections 31 of the drive unit 3 to the first connection interface 24 of the steering gear 4. By way of example, the printed circuit board connections 31 may be formed by a plug-in connector connection in each case, via which the intermediate component 30 is able to be connected.

As schematically illustrated in FIG. 3, the electrical intermediate component 30 is in the form of a further lead frame 33, which uses the available plug-in connector connections for connection to the control apparatus 16. The further lead frame 33 may have the same design as the lead frame 17 described in FIG. 2, wherein the further lead frame 33, for this purpose, is formed by a plurality of individual conductors that are embedded in a potting body and the ends of which form, or contribute to forming, the first counterpart interface 24 and the further counterpart interface 32. Sections of the further lead frame 33 may be installed inside the drive housing 14 or integrated into the drive housing 14.

As schematically illustrated in FIG. 4, the electrical intermediate component 30, in an alternative embodiment variant, is in the form of a connection cable 34 that is used for connection to the printed circuit board connection 31. By way of example, the connection cable 34 is in the form of a flexible adapter cable, which has the first counterpart interface 24 and the further counterpart interface 32 on the end thereof. The connection cable 34 may be laid in a protected manner inside the drive housing 14 and/or inside a protective tube, which is not shown, arranged in or on the drive housing 14.

FIG. 5 shows the second gear input 7 of the gear housing 5, wherein the second connection interface 19 is in the form of a socket integrated into the gear housing 5. The sensor 13 is connected to the second connection interface 19 via a connecting cable, which is also referred as a “pigtail cable adapter”, that is laid inside the sensor housing 12. The end of the connecting cable has the second counterpart interface 25, which is in the form of a plug that is complementary to the socket in order to form the plug-in connection 23. By way of example, the connecting cable may be connected directly, in particular non-detachably, to the sensor 13 or may be connected detachably to the sensor 13 via a further plug-in connection.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Steering system
2 Sensor unit
3 Drive unit
4 Steering gear
5 Gear housing
6 First gear input
7 Second gear input
8 Gear output
9 Drive shaft
10 Steering shaft
11 Output shaft
12 Sensor housing
13 Sensor
14 Drive housing
15 Servomotor
16 Control apparatus
17 Lead frame
18 First connection interface
19 Second connection interface
20 Individual conductor
21 Potting body
22 Electrical contacts
23 Plug-in connection
24 First counterpart interface
25 Second counterpart interface
26 Guide contour
27 Guide grooves
28 Fastening sections
29 Printed circuit board
30 Electrical intermediate component
31 Printed circuit board connection
32 Further counterpart interface
33 Further lead frame
34 Connection cable

1. An electric steering system, comprising:
a sensor unit, wherein the sensor unit has at least one sensor for recording steering information from a steering shaft;
an electric drive unit for generating an electrical auxiliary force, wherein the electric drive unit has an electric servomotor and a control apparatus, wherein the control apparatus is designed to control the electric servomotor based on the recorded steering informations; and
a steering gear, wherein the steering gear has a gear housing, which has a first gear input for connecting a drive shaft to the electric drive unit, a second gear input for connecting the steering shaft to the sensor unit and a gear output for connecting an output shaft to at least one steerable vehicle wheel, wherein the electric drive unit is connected to the gear housing at the first gear input and the sensor unit is connected to the gear housing at the second gear input,
wherein
the sensor unit and the electric drive unit are connected to one another, electrically and/or in terms of signaling, via a lead frame arranged in the gear housing.

2. The electric steering system as claimed in claim 1, wherein the lead frame is designed to be rigid or substantially rigid.

3. The electric steering system as claimed in claim 1, wherein the lead frame has a plurality of individual conductors that are electrically insulated from one another and, at their free ends, each form an electrical contact for at least indirectly connecting the electric drive unit and/or the sensor unit.

4. The electric steering system as claimed in claim 1 wherein the lead frame has an electrically insulating potting body.

5. The electric steering system as claimed in claim 1, wherein the lead frame forms, on a side of the first gear input, a first connection interface for electrically connecting the electric drive unit and, on a side of the second gear input, a second connection interface for electrically connecting the sensor unit, wherein the first and/or the second connection interface are/is designed to form an electrical plug-in connection.

6. The electric steering system as claimed in claim 5, wherein the first and/or the second connection interface for forming the electrical plug-in connection are/is in the form of a socket integrated into the gear housing or a plug integrated into the gear housing.

7. The electric steering system as claimed in claim 5, wherein the control apparatus has a printed circuit board, wherein the printed circuit board is connected to the first connection interface directly via a printed circuit board connection or via at least one electrical intermediate component.

8. The electric steering system as claimed in claim 7, wherein the electrical intermediate component is in a form of a further lead frame that connects the printed circuit board to the first connection interface.

9. The electric steering system as claimed in claim 7, wherein the electrical intermediate component is in a form of a connection cable that is guided in a protected manner and that connects the printed circuit board to the first connection interface.

10. The electric steering system as claimed in claim 5, wherein the at least one sensor is connected to the second connection interface via a connecting cable that is guided in a protected manner.

11. The electric steering system as claimed in claim 1, wherein the gear housing has a guide contour complementary to the lead frame, wherein the lead frame interacts with the guide contour with a form-fit and/or with a force-fit.

12. The electric steering system as claimed in claim 11, wherein the guide contour is formed by at least one guide groove into which at least sections of the lead frame are inserted.

13. The electric steering system as claimed in claim 1, wherein the gear housing has at least one fastening receptacle and the lead frame has at least one fastening section, wherein the fastening section is received in the fastening receptacle with a form-fit and/or with a force-fit.

14. The electric steering system as claimed in claim 1, wherein the lead frame is shaped to an inner contour of the gear housing.

15. A vehicle comprising the electric steering system as claimed in claim 1.
